(19) United States
(12) Patent Application Publication
(10) Pub. No.: US 2026/0271108 A1
(43) Pub. Date: Sep. 10, 2026

(54) DEVICE DISCOVERY FOR AGGREGATED WTRU

(71) Applicant: InterDigital Patent Holdings, Inc., Wilmington, DE (US)

(72) Inventors: Magurawalage Chathura Madhusanka Sarathchandra, London (GB); Jaya Rao, Montreal (CA); Saad Ahmad, Montreal (CA); Michael Starsinic, Newtown, PA (US)

(21) Appl. No.: 19/167,007

(22) PCT Filed: Mar. 25, 2024
(86) PCT No.: PCT/US2024/021271

§ 371 Date: Sep. 19, 2025

Related U.S. Application Data
(60) Provisional application No. 63/454,474, filed on Mar. 24, 2023.

(51) Int. Cl. H04W 76/14; H04W 8/00; H04W 8/24

(52) U.S. Cl. CPC H04W 76/14; H04W 8/005; H04W 8/24

(57) ABSTRACT

Procedures, methods, architectures, apparatuses, systems, devices, and computer program products for wireless device discovery of aggregated devices. For example, a wireless device may be configured to discover other wireless devices with the assistance of an anchor wireless device and/or a network, such as to create or join an aggregation with the other wireless devices. The aggregation may provide and/or consume services associated with an application. For example, a wireless device may be configured to establish connectivity with the other wireless devices with the assistance of an anchor wireless device and/or a network, such as to create or join the aggregation.

### CROSS-REFERENCE TO RELATED APPLICATIONS

This application claims the benefit of U.S. Provisional Patent Application No.63/454,474 filed 24-Mar-2023, which is incorporated herein by reference.

### TECHNICAL FIELD

The present disclosure is generally directed to the fields of communications, software and encoding, including, for example, to methods, architectures, apparatuses, systems directed to device discovery of wireless transmit/receive units (WTRUs), and more particularly to discovery of aggregated WTRUs.

### BACKGROUND

Device-to-Device (D2D) direct communication protocols enable two devices to communicate directly between them with or without the aid of the network. Different scenarios exist for D2D communication depending on whether the WTRUs involved are within the coverage of a cellular network or not. In the 3rd Generation Partnership Project (3GPP), fifth generation (5G) new radio (NR) Sidelink (SL) was introduced in Release 16 to enable proximate devices to directly communicate without packets going through the 3GPP network. Targeted applications include mission critical services, vehicle to everything (V2X) services and Industrial Internet of Things (IIoT). D2D communication promises ultra-low latency links and is therefore an attractive solution for various emerging applications such as augmented reality (AR), virtual reality (VR), and extended reality (XR).

V2X communications may include one or more of vehicle-to-vehicle (V2V) communications, vehicle-to-pedestrian (V2P) communications, vehicle-to-infrastructure (V2I) communications and Vehicle-to-Network (V2N) communications. V2X WTRUs may engage in V2X communications. IIoT may include interconnected sensors, instruments, WTRUs, and other devices to improve automatic industrial applications, including manufacturing, energy management and the like.

D2D direct communication protocols support two key technologies: (1) proximity services (ProSe) and (2) group communication. ProSe services allow devices which are within proximity to each other to communicate with each other. This is enabled by D2D discovery and D2D direct communication procedures. Discovery mechanisms allow a WTRU to discover another WTRU in its proximity, which may be performed directly by WTRU or through the network. Group Communication mechanisms allow one-to-many communication among WTRUs in a highly resource efficient manner, allowing messages to be disseminated easily to a large group of people, over a common downlink stream.

### SUMMARY

Devices and procedures for device discovery for aggregated devices are described herein.

In an example, a WTRU may receive information related to WTRU Aggregation. The WTRU may transmit a registration request message. Further, the WTRU may receive a registration accept message and transmit a registration complete message. Also, the WTRU may receive a configuration message, wherein the configuration message includes information regarding an Anchor WTRU. Moreover, the WTRU may trigger WTRU Aggregation discovery. Additionally, the WTRU may detect device density. In addition, the WTRU may transmit a discovery request message. Also, the WTRU may authorize a requested service. Further, the WTRU may receive a discovery response message. Also, the WTRU may transmit a discovery acknowledgement (ACK). Moreover, in an example, a User identity (ID) may be included in one or more of: the information related to WTRU Aggregation, the registration request message, the discovery request message, or the discovery response message.

Additionally, the WTRU may establish sidelink (SL) and Uu communications. Moreover, the WTRU may notify an application of a newly joined WTRU. In an example, the information related to WTRU Aggregation may include one or more of: known services, known member WTRUs, known anchor WTRUs and known aggregations. Further, the registration request includes an indication of an ability of a WTRU to become an Anchor WTRU.

In an example, a first WTRU may receive, from an anchor WTRU, information indicating a capability of the anchor WTRU to support WTRU aggregation at. The first WTRU may receive, from the anchor WTRU, a discovery request message including information indicating one or more services which are associated with WTRU aggregation. The first WTRU may send, to the anchor WTRU, a discovery response message including information indicating at least one of the services which are supported by the first WTRU. The first WTRU 102 may receive, from the anchor WTRU, an acknowledgment message including information indicating the first WTRU is confirmed in a WTRU Aggregation that includes one or more second WTRUs. The WTRU Aggregation is associated with the indicated at least one of the services. At, the first WTRU 102 may establish communications, via the anchor WTRU, with the one or more second WTRUs of the WTRU Aggregation.

In an example, an anchor WTRU may send information indicating a capability of the anchor WTRU to support WTRU aggregation. The anchor WTRU may send a discovery request message including information indicating one or more services which are associated with WTRU aggregation. The anchor WTRU may receive, from a first WTRU, a discovery response message including information indicating at least one of the services which are supported by the first WTRU. The anchor WTRU may send, to the first WTRU, an acknowledgment message including information indicating the first WTRU is confirmed in a WTRU Aggregation that includes one or more second WTRUs. The WTRU Aggregation is associated with the indicated at least one of the services.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of aggregated WTRUs for a single user with an anchor WTRU, for providing user experiences;

FIG. 3 is a procedural diagram illustrating an example of discovering WTRU aggregations for a single user/application, and an example of WTRU discovery for WTRU aggregation, with both examples of providing services for the primary WTRU;

FIG. 4A is a procedural diagram illustrating an example of a procedure for anchor WTRU-initiated WTRU aggregation group discovery;

FIG. 4B is a procedural diagram illustrating an example of a procedure for participating WTRU-initiated WTRU aggregation group discovery;

FIG. 5 is a procedural diagram illustrating an example of provisioning WTRU Aggregation information via system information (SI);

FIG. 6 is a procedural diagram illustrating an example of WTRU aggregation discovery for a WTRU;

FIG. 7 is a procedural diagram illustrating another example of WTRU aggregation discovery for a WTRU;

FIG. 8 is a procedural diagram illustrating an example of WTRU aggregation discovery for an anchor WTRU;

FIG. 9 is a procedural diagram illustrating another example of WTRU aggregation discovery for an anchor WTRU;

FIG. 10 is a procedural diagram illustrating an example of using SI for forming a WTRU aggregation;

FIG. 11 is a procedural diagram illustrating an example of using SI for joining a WTRU aggregation;

FIG. 12 is a procedural diagram illustrating an example of WTRU aggregation discovery;

FIG. 13 is a procedural diagram illustrating another example of WTRU aggregation discovery;

FIG. 14 is a procedural diagram illustrating another example of WTRU aggregation discovery;

FIG. 15 is a procedural diagram illustrating another example of WTRU aggregation discovery; and

FIG. 16 is a procedural diagram illustrating an example of connecting to a WTRU Aggregation.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

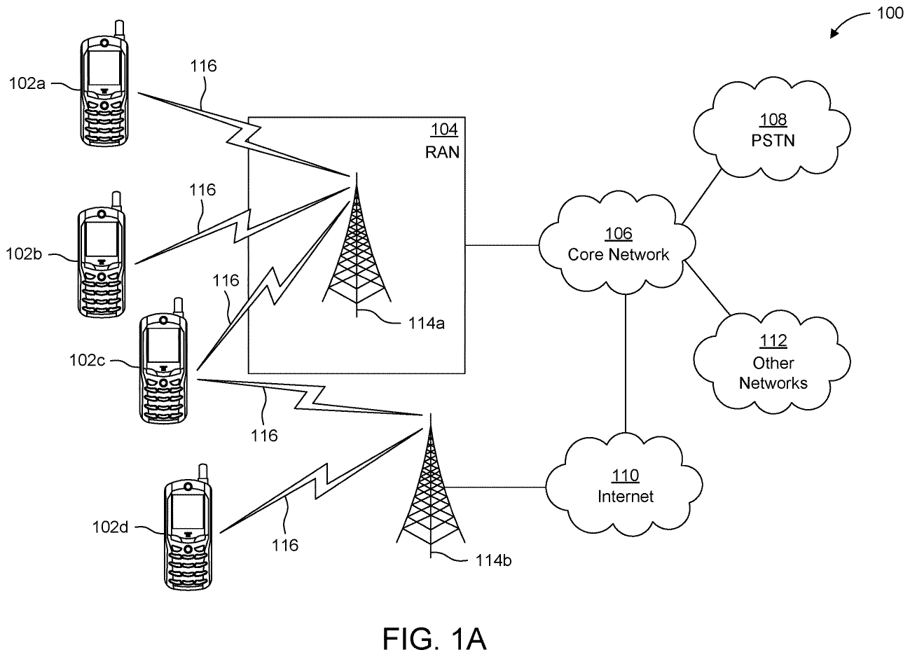

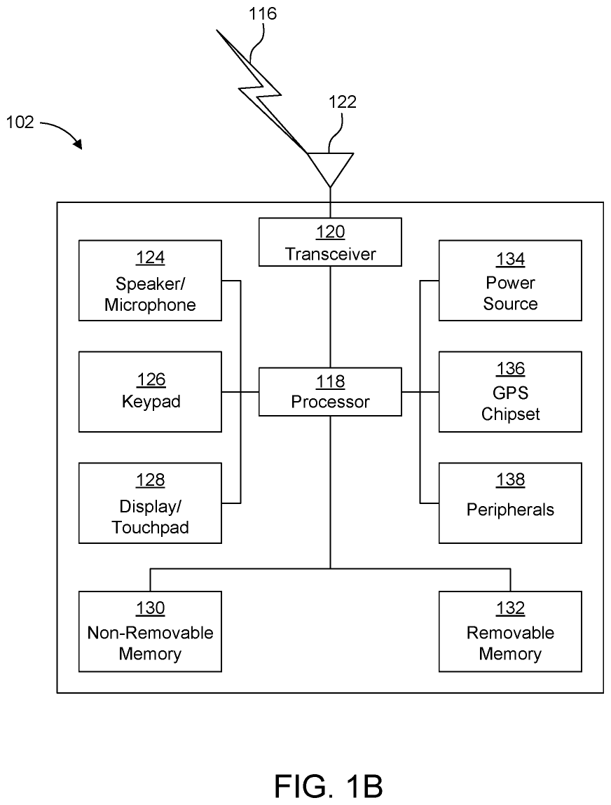

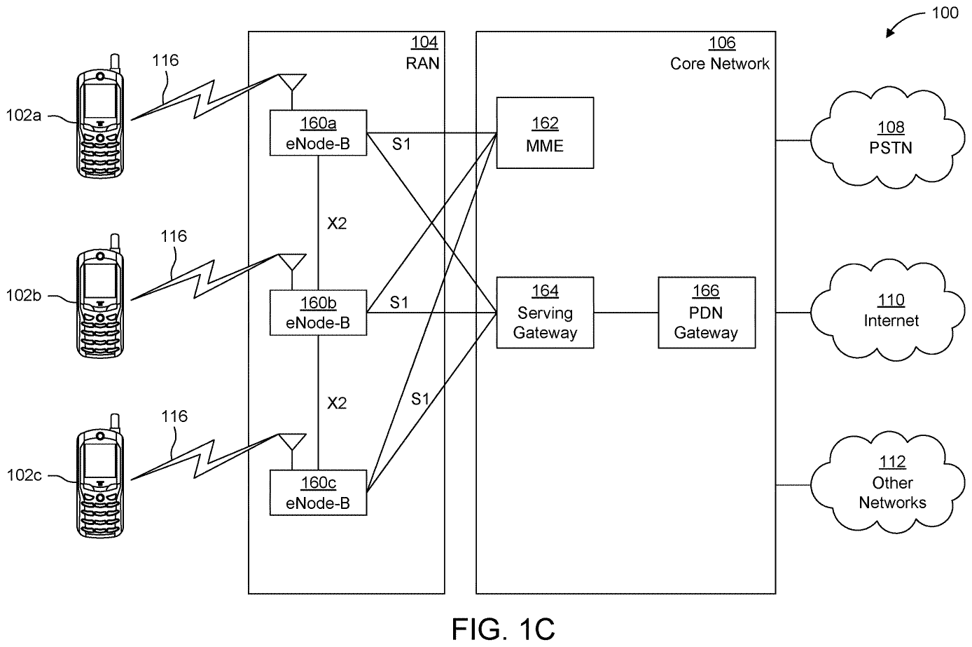

Example Communications System The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

For unicast communication, communicating entities use Layer-2 identity (ID) for (e.g., uniquely) identifying the WTRUs. An application Layer ID may be associated with one or more vehicle-to-everything (V2X) applications within the same WTRU, while in scenarios where the WTRU has more than one application layer ID, each Application Layer ID of the same WTRU is seen as a different WTRU. The WTRU maintains the Application Layer ID and the Layer-2 IDs used for unicast links, and the applications may not use the Layer-2 IDs and instead may use Application Layer ID, allowing to change the Layer-2 IDs without requiring to update the applications.

User IDs such as evolved packet core (EPC) ProSe User ID (e.g., uniquely) identifies a WTRU registered for ProSe. Application Layer Group ID (e.g., uniquely) identifies an application layer group that the WTRU belongs to, a user within the context of a specific application or a group of users within the context of a specific application. The following definition may be understood by those of ordinary skill in the art: For commercial services, the Application Layer Group ID is provided by Application Server; and for public safety services, the pre-configured or provisioned Application Layer Group ID will be used for groupcast communication.

Given the increased bandwidth and processing requirements of emerging applications such as extended reality (XR)/Metaverse, one way to satisfy those requirements is to aggregate resources of more than one device. Aggregating communication (e.g., throughput, coverage) and computing capabilities of multiple WTRUs when serving a single application and/or a single user, allows systems to provide resources are services that satisfy requirements of such applications.

Combining capabilities of multiple WTRUs also allows to provide enhanced user experiences. For example, instead of providing an application experience using a single WTRU (that is rather limiting due to various factors such as the form factor, limited batter life), where audio, video and haptic information are presented to the user, the audio, video, and haptic information may be presented to the user by aggregating a VR headset, headphones, and a haptic suit, for the same application and the user, making the application experiences truly immersive.

Emerging multimodal media applications require the user to utilize multiple devices/WTRUs for the same application, e.g., a user playing a fully immersive game using VR headset, haptic suit, and a game controller at the same time. Likewise, various emerging IoT applications require the utilization/deployment of a collection of IoT devices including sensors for serving a single application and a user. In such scenarios, for achieving a common task (e.g., application), a group of WTRUs/devices are associated with each other and with a specific user for the purpose of the application, improved QoS/quality of experience (QoE), and/or system efficiency. This is in contrast to a user utilizing only a single device for consuming an application, e.g., a user using her mobile device to play a game.

To provide a single application or experience for a single user using multiple (WTRUs) devices at the same time, there is a need for mechanisms to associate, connect and manage multiple WTRUs together. In such scenarios, the set of WTRUs/devices that serve the user incur high dependency.

Traffic which belong to the same application experience may be distributed across those devices over D2D direct communication links. In examples, traffic may include one or any combination of data, frames, packets, streams, flows, PDUs or the like. In a further example, direct communication links may be utilized to improve user experience. Therefore, the delivery (and reception) of those data among the devices that are grouped for a single user, must be associated, and coordinated.

The requirements of the devices and traffic being transferred, for a single multi-modal application (involves multiple modes of communication, e.g., audio, video, haptic), within an aggregated group of WTRUs for a single user may vary. For example, a subset of the traffic may require high priority transmission that is sent to a subset of the devices within the aggregated WTRUs, and if such traffic experiences any disruptions or any degradation to its QoS, the overall services, application or experience will be negatively impacted. In contrast, a subset of devices or traffic in the same aggregated group of WTRUs may be less important, and therefore any disruptions (e.g., delays, dropped packets) to those devices may not significantly affect the overall operation, the end goal of the user (e.g., a task to be performed by a group of WTRUs, devices, Robots or unmanned aerial vehicles (UAVs)) or the delivery of crucial data.

A first step in solving above scenarios is to discover member WTRUs and WTRU Aggregations that are configured to serve a single user. For doing so, this disclosure addresses the following sub-problems.

The existing 5G procedures define powerful features, e.g., QoS, session management, mobility management. However, almost all these features are designed for one WTRU. At the network side, the WTRU context is also managed per WTRU granularity by Network Functions, e.g., by unified data management (UDM)/session management function (SMF)/ access and mobility function (AMF), and the like. Moreover, the majority of the features are based on the assumption that one WTRU can finish the task.

The existing 5G procedures do not allow a set of devices in direct D2D communications to be aggregated and associated with a single user. The existing Application Layer Group ID allows for identifying a user within the context of a specific application or to identify a group of users within the context of a specific application. However, this is not sufficient to group a set of WTRUs associated with a specific user for the purpose of consuming a single application or an experience. For example, if two users are playing a game, both using multiple WTRUs, both users may have the same Application Layer Group ID. The Application Layer Group ID does not enable the grouping of specific WTRUs that are serving a single user. Moreover, procedures must be developed for discovering WTRUs for WTRU Aggregations, for later associating them with specific aggregations (and therefore an aggregation IDs). Likewise, procedures must be developed for discovering existing WTRU Aggregations (or the services offered by those aggregations) that may be of interest to other WTRUs. This disclosure presents methods and procedures which enable WTRUs to discover other WTRUs for forming new WTRU Aggregations, and existing WTRU Aggregations for consuming existing services or for providing its own services. Further, embodiments and examples herein include collaborative devices and multi-sensory XR over wireless communication.

### Overview

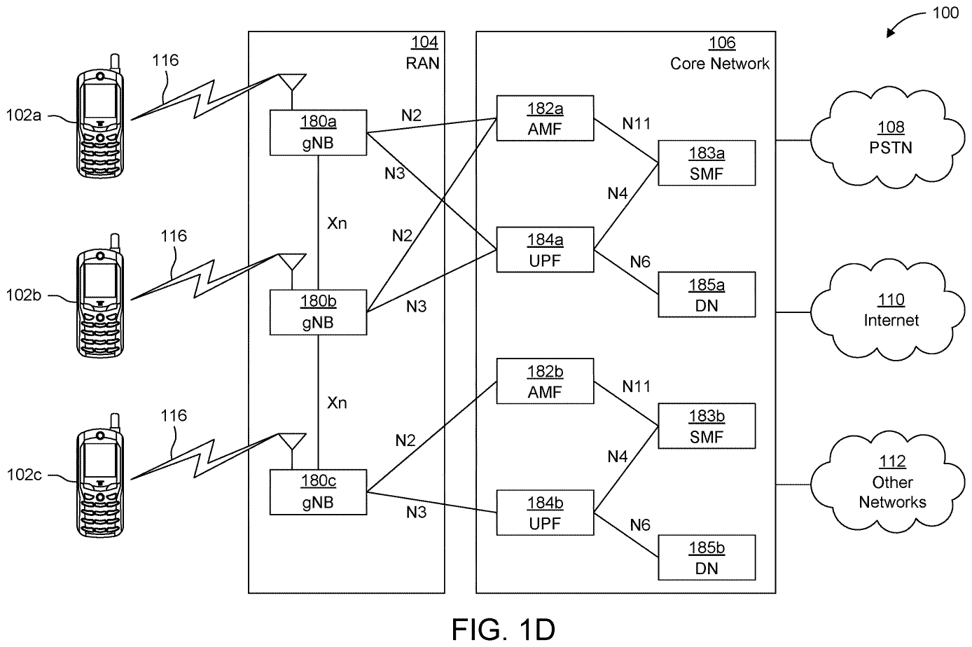

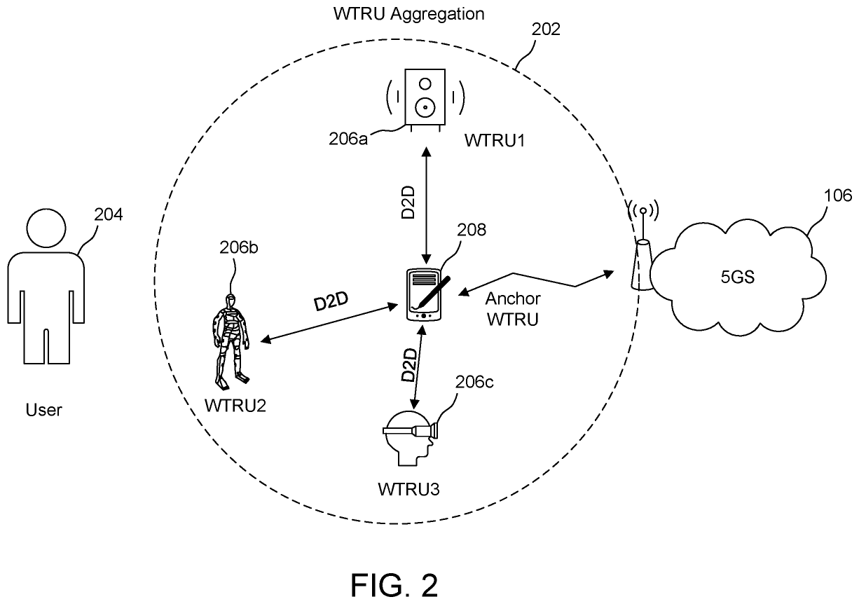

FIG. 2 is a system diagram illustrating an example of aggregated WTRUs for a single user with an anchor WTRU, for providing user experiences. In an example shown in FIG. 2 illustrates a single Aggregation 202 of a collection of WTRUs 102 for the purpose of providing an application experience for a single user 204. This demonstrates that per a given WTRU Aggregation 202, multiple WTRUs 102 with varying form factors, such as a WTRU1 206a (e.g., sound system), a WTRU2 206b (e.g., haptic suit) and a WTRU3 206c (e.g., VR goggles) may be used, and that they communicate over D2D communication mechanisms, for rendering a single experience for the user 204. In some scenarios, an Anchor WTRU 208 (e.g., a WTRU 102) may assist in the establishment of the WTRU Aggregation, which may communicate over D2D communication to other WTRUs 102. The anchor WTRU 208 may be one of WTRUs 102 that is part of the application experience, while in some scenarios, it may be a WTRU 102 that does not participate in providing the application experience to the user 204 (e.g., a dedicated device that assists in WTRU Aggregations provided by an operator).

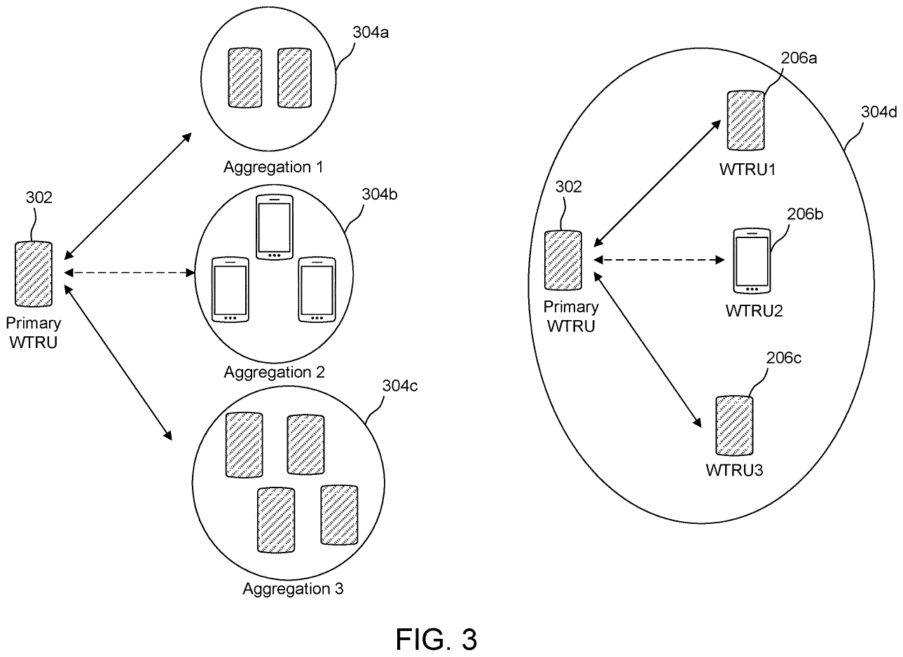

FIG. 3 is a procedure diagram illustrating an example of discovering WTRU Aggregations for a single user and/or application, and WTRU discovery for WTRU aggregation, both for providing services for a primary WTRU 302. In contrast to FIG. 2, an example shown in the left-hand side of FIG. 3, depicts a scenario where a primary WTRU 302 discovers existing WTRU Aggregations 304a, 304b, 304c which provide services to other WTRUs 102 (as opposed to providing a user experience). Likewise, an example shown in the right-hand side of FIG. 3 depicts a scenario where a single primary WTRU 302 discovers other WTRUs 102 that are providing services required by the primary WTRU 302, for establishing a WTRU Aggregation. In both scenarios, shaded WTRUs/Aggregations indicate the WTRUs/Aggregations chosen by the primary WTRU 302 through discovery, while non-shaded WTRUs/Aggregations indicate the ones that were not chosen and/or used. In both scenarios, a single WTRU 102 may discover services provided by nearby WTRU Aggregations 304 and/or WTRUs 102 to help execute an application experience. However, the primary WTRU 302 depicted in the scenarios of the FIG. 3 may be part of a larger WTRU Aggregation, such as the one depicted in the FIG. 2, where it may serve as a member WTRU 102 or an Anchor WTRU 208.

Each WTRU Aggregation 304 may be identified by a WTRU Aggregation ID. Moreover, the WTRU Aggregation ID serves a different functionality to the existing Application Layer Group ID. For example, if two players are playing the same game, and both users have multiple WTRUs 102, both users will have the same Application Layer Group ID, but different Aggregation IDs.

In the embodiments and examples provided herein, the terms WTRU Aggregation and WTRU Aggregation Group may be used interchangeably. Further, embodiments and examples provided herein may specify when multiple WTRU Aggregations are used.

Discovery procedures may be executed prior to establishing D2D connectivity for multimodal/XR applications. The procedures may apply to both scenarios presented above, i.e., 1) discovery of WTRU Aggregations 304, WTRUs 102 and services for creating a user experience, 2) discovery of WTRU Aggregations 304, WTRUs 102 and services by a WTRU for executing a task in a distributed manner.

In examples, two types of devices may be discovered or chosen for the applications. A first type may include known services, known WTRUs, and/or known WTRU Aggregations which are: (i) WTRUs, Aggregations, and services that are known to the application (e.g., WTRUs that were previously used), (ii) WTRUs, Aggregations, services that are known to the member WTRUs of an Aggregation, and/or (iii) WTRUs, aggregations, services that are known to the 5G system (5GS) as previously used by the same application or the user. A second type may include unknown services, WTRUs and Aggregations where the discovery procedures primary apply to the discovery of unknown aggregations, WTRUs and services, while the information of known services, WTRUs and Aggregations may be provisioned or initialized.

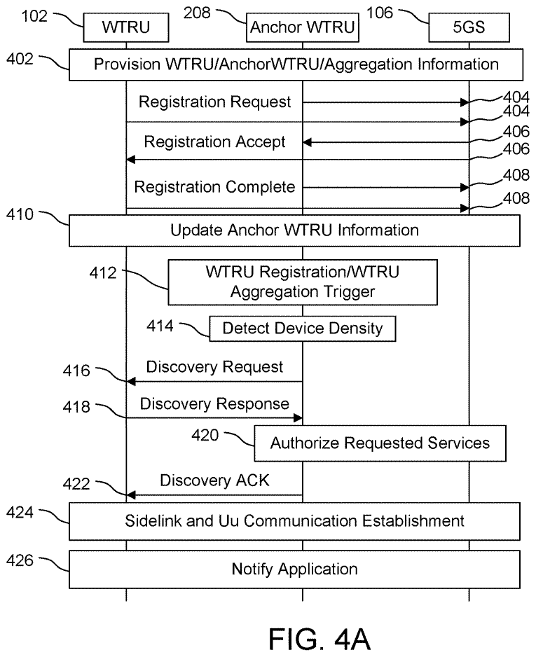

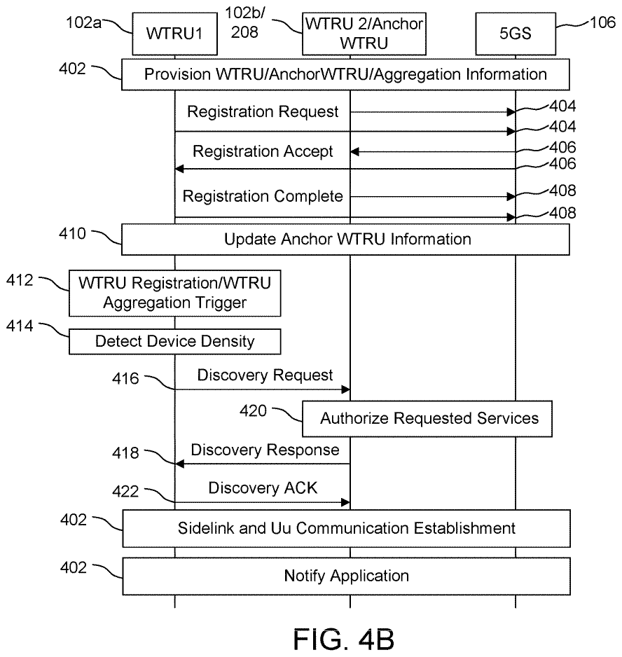

FIG. 4A is a procedural diagram illustrating an example of a procedure for anchor WTRU-initiated WTRU aggregation group discovery. FIG. 4B is a procedural diagram illustrating an example of a procedure for participating WTRU-initiated WTRU aggregation group discovery.

The examples shown in FIGS. 4A and 4B may include the following steps for the procedures for WTRU Aggregation discovery.

At 402, the WTRUs 102, anchor WTRUs 208 and the network components are initialized or provisioned with the information related to WTRU Aggregations 304. In examples, the network components may include one or more of an SMF, a policy control function (PCF), a network data analytics function (NWDAF) or the like. The information related to WTRU Aggregations 304 may entail known services, known member WTRUs 102, known anchor WTRUs 208, and known Aggregations 304 that can/were previously used by the same application or the user/subscriber. Such information may include any combination of the following.

The information related to WTRU Aggregations 304 may include Aggregation ID(s), which may specify the WTRU Aggregation(s) 304. In an example, a WTRU Aggregation ID(s) may be WTRU specific.

Further, the information related to WTRU Aggregations 304 may include a user ID, such as the user/subscriber the aggregation belongs to. An identifier may (e.g., uniquely) identify a real user (e.g., using subscriber information, subscription permanent identifier (SUPI)/subscription concealed identifier (SUCI) or the like). In an example, the user ID may be network specific.

Also, the information related to WTRU Aggregations 304 may include session ID(s), such as session being used within the application. For example, the session may be a multimodal session. In an example, the Session ID(s) may be network specific.

In addition, the information related to WTRU Aggregations 304 may include WTRU IDs, such as the IDs of the WTRUs that are already known that is or will be part of the Aggregation, such as source/Destination Layer-2 IDs. In an example, the WTRU IDs may be WTRU specific.

Moreover, the information related to WTRU Aggregations 304 may include WTRU capabilities. For example, the WTRU capabilities may include one or any combination of sidelink capabilities, game rendering capabilities or the like. In an example, WTRU capabilities may be WTRU specific.

Additionally, the information related to WTRU Aggregations 304 may include time durations, such as a time duration of how long a WTRU Aggregation 304 may last and/or a time duration of how long one or multiple D2D communication links may last. In an example, the time durations may be WTRU specific.

In a further example, the information related to WTRU Aggregations 304 may include application layer IDs, such as application layer IDs associated with direct communication within a WTRU Aggregation 304.

Additionally, the information related to WTRU Aggregations 304 may include information of supported services. This may include a vector of services, each record containing information of the specific service (e.g., service ID, service requirements, supported multimodal flows, or the like). In an example, the vector of services may be represented in a table, with each row corresponding to a service, and each column representing a property of the service (e.g., service ID, bandwidth (BW) requirements, latency requirements, and the like).

Further, the information related to WTRU Aggregations 304 may include a density of devices within the vicinity (e.g., cell). This may be specified either as a specific number, i.e., number of devices, or as an indication (e.g., low, medium, high). In an example, the WTRUs 102 understand how to interpret information conveyed in this parameter. For example, a WTRU 102 may process received density related information and deduce or infer the level of device density around the user. For example, the density level may be classified as, low, medium and high. This value is then later used for deciding the periodicity of discovery messages.

In an example, WTRUs 102 may register (or updates existing registration) with the network at 404, 406 and 408. The WTRU may indicate its capability to become an Anchor device 208 for a WTRU Aggregation or for multiple WTRU Aggregations, as such, this step may be used for registering as an Anchor device 208, associated with or without a specific WTRU Aggregation 304. In some scenarios, WTRU Aggregation capability may be indicated as part of any of a V2X, ProSe, and/or Sidelink capability indication. In an example, an Anchor WTRU 208 may send a registration request to the network. In a further example, another WTRU 102 may send a registration request to the network.

If a WTRU 102 is already aware of an existing WTRU Aggregation 304 that it likes to join, it includes the corresponding WTRU Aggregation ID in this request, such as including information of hosted/supported services by the WTRU 102. This may include a vector of services, each record containing information of the specific service (e.g., service ID, service requirements, supported multimodal flows).

If a WTRU 102 is to create a new WTRU Aggregation 304, it may include any combination of following. The WTRU 102 may include WTRU Aggregation ID(s), specifying the WTRU Aggregation(s). Further, the WTRU 102 may include a User ID, which may show the user/subscriber the aggregation belongs to. The User ID may be an identifier (e.g., uniquely) identifying a real user, for example, using subscriber information, SUPI/SUCI.

Further, the WTRU 102 may include session ID(s), which may identify session(s) being used within the application (e.g., multimodal session). Also, the WTRU may include WTRU IDs, such as the IDs of the WTRUs 102 that are already known that are or will be part of the aggregation. Moreover, the WTRU 102 may include WTRU capabilities (e.g., sidelink capabilities, game rendering capabilities). In addition, the WTRU 102 may include time durations (e.g., time duration the WTRU Aggregation 304 is to last and/or time durations the one or multiple D2D communication links are to last), and therefore the resources to be allocated. Further, the WTRU 102 may include the Application Layer ID(s) associated with direct communication within the WTRU Aggregation 304.

Additionally or alternatively, a WTRU Aggregation ID may be created by the network (e.g., by AMF, SMF) or by the application layer (e.g., application function (AF)/ application server (AS)), and provided to the WTRUs 102.

This message may indicate its availability/interest to participate in any WTRU Aggregations in the future. In this case, the WTRU 102 shall include one or more of the following information. For example, the WTRU 102 may include Aggregation IDs of the target desired group communications. Also, the WTRU 102 may include traffic related requirements information such as UL/DL foreseeable traffic size and type. Further, the WTRU 102 may include a specific time at which the WTRU 102 wants to engage in the communications. Additionally, the WTRU 102 may include a time window (if the WTRU can produce it) for which the WTRU 102 wants to engage in communications. Moreover, the WTRU 102 may include a particular user or WTRU ID(s) (or a set/subset of them) that the registering WTRU 102 may know in advance it will communicate directly with. In addition, the WTRU 102 may include an Application ID/Application Group ID indicating interest in a specific application or a service. In some scenarios, multiple instances of this field may be specified.

Further, the WTRUs 102 may receive a Registration Accept message from the 5G system at 406. This message may contain the WTRU Aggregation ID, either generated by the RAN, AMF, SMF or PCF, or provided to the network by the AF/AS. The WTRUs 102 respond to the 5G system with a Registration Complete message at 408. The Registration Accept message may include information of the services and the WTRU Aggregations 304 that are supported by the public land mobile network (PLMN), Cell, the base station, or WTRUs, and information related to how to access those services and WTRU Aggregations.

At 410, the WTRUs 102 may receive a configuration message with the information of the newly assigned anchor WTRU 208 as well as the WTRU Aggregations 304 that are associated with the anchor WTRU 208, and the information related to the sidelink communication (e.g., allocated resources for sidelink communication, including time, frequency, physical resource blocks (PRBs), and/or the sidelink resource allocation mode). The information of the anchor WTRUs 208, as well as the information of the WTRU Aggregations 304 will be received by the 5G core network (e.g., AMF, SMF, PCF) as well as application layer components (e.g., AF/AS in the network and/or application running on the WTRU).

WTRU Aggregation discovery may be triggered by various trigger events at 412. Examples of such triggers include, but are not limited to, an application layer notification (from application running on the WTRU or AF/AS in the network) to establish a WTRU Aggregation, WTRU/Anchor WTRU registration with the 5G system, based on a pre-configured time. Moreover, discovery messages from/to known WTRUs may be ignored, as the purpose of the discovery procedures is to discover unknown devices. The triggering of the WTRU Aggregation discovery may vary as per the two example options listed below.

In a first option shown in FIG. 4A, which may be referred to as option 1, the Anchor WTRU 208 may operate in scenarios where the Anchor WTRU 208 advertises its capabilities and information regarding WTRU Aggregations 304 (and the resources being allocated), the WTRUs 102 (WTRUs that are already part of existing WTRU Aggregations and WTRUs that are available to be part of new WTRU Aggregations), and the services. These announcement messages may be broadcasted (e.g., through broadcast or multicast) and therefore, can be received by another WTRU 102, or may be announced targeting specific WTRUs 102 (e.g., restricted discovery procedures, as will be understood by persons having ordinary skill in the art).

In a second option shown in FIG. 4B, which may be referred to as option 2, the WTRUs 102 to participate in a WTRU Aggregation may send discovery announcement messages over a PC5 reference point and announces its capabilities, and services being offered (e.g., multimodal services) over a PC5 interface, which in turn may be used by the Anchor WTRU 208 (received through monitoring) for identifying suitable WTRUs in the proximity. These announcement messages may be broadcasted and therefore, can be received by another WTRU 102, or may be announced targeting specific WTRUs 102 (e.g., restricted discovery procedures as will be understood by persons having ordinary skill in the art).

The WTRU(s) 102 may receive information related to the density of WTRUs in the vicinity (e.g., cell). Additionally or alternatively, this may be detected in different ways. Additionally or alternatively, it may be detected based on the device density parameter received at 402, or it may use other mechanisms such as Integrated Sensing and Communication (i.e., radio wave transmissions, reflections, and scattering used to sense and better understand the physical world). Therefore, the WTRU 102 may be configured for 3 scenarios: 1) the WTRU 102 receives density related information; 2) the WTRU 102 detects density; and/or 3) the WTRU 102 receives partial density related information and then the WTRU 102 combines local capabilities (e.g., sidelink) to detect more accurate and up-to-date density related information. Exact mechanisms on detecting device density are out of the scope of the details of the examples provided herein.

However, once detected, a WTRU 102 may receive the density related information from the network (e.g., cell), or from other WTRUs 102. The WTRU 102 may use this information to decide the periodicity of an WTRU Aggregation discovery message. The message may be an aperiodic message and may be sent considering any combination of the following conditions: there are known devices; device-local resources have reached a critical level (e.g., battery level below a certain threshold); and/or a low density of devices. Further, the message may be a periodic message and may be sent based on the detected level of the density (increased periodicity when the density is high, reduced periodicity when the density is low) of devices in the vicinity, to ensure that all devices receive the message.

At 416, the WTRU(s) 102 may receive an WTRU Aggregation discovery message from another anchor WTRU 208. In FIG. 4A, this message may be sent by an anchor WTRU 208 to the WTRU 102. In FIG. 4B, this message may be sent by the WTRU 102 to the anchor WTRU 208. This message may include any of the following. In an example, the information included in this message may be two-fold. Depending on the scenario, this message may either be used as an advertisement of available capabilities, or a request to discover available services/WTRUs/WTRU Aggregations. This is analogous to ProSe model A and model B discovery mechanisms, and may extend existing mechanisms with the following added parameters.

The message may include services that are provided by the WTRU 102. These are the services provided by the WTRU 102 to other WTRUs. Therefore, this part of the message may be used as an advertisement of available capabilities. The capabilities may be pre-defined and may be specified as an index. The capabilities themselves may be specified at the resource level (e.g., central processing unit (CPU), graphics processing unit (GPU), memory, Sidelink/RAT) or function/service level (e.g., Unity game engine). For example, the WTRU 102 may provide game processing capabilities to other WTRUs/Aggregations.

Also, the message may include services that are required by the WTRU 102. These are services/capabilities required by the WTRU 102. For example, the WTRU 102 discovers WTRU Aggregations 304 that provide processing capabilities of a game. In an example, the message may be a discovery request message.

Several parameters may be included in the message. For example, the message may include WTRU Aggregation ID(s). Further, the message may include a ProSe application code/ID, identifying the specific multimodal/XR application. Also, the message may include time duration/resources, which may include any combination of a time window, a start time, an end time. The time duration/resources may be at the level of WTRU Aggregation, or at the level of individual sidelink links. Further, the time duration/resources may correspond to the length of the communication session. Moreover, the message may include traffic related requirements such as UL/DL foreseeable traffic size and type. In addition, the message may include particular users/subscribers associated with an identifier (e.g., uniquely) identifying a real user, e.g., using subscriber information, SUPI/SUCI. Additionally, the message may include WTRU IDs (or a set/subset of them) that the WTRU 102 may know in advance it will communicate directly with or the WTRU Aggregations 304 are associated with.

This message may include information of the services and the WTRU Aggregations 304 that are supported by the PLMN, cell, the base station, or WTRUs 102, and information related to how to access those services and WTRU Aggregations 304. Also, this message may include the information of services (e.g., specific single-modal service that is part of a larger multimodal application) required by a WTRU(s) 102 and/or Aggregation(s) 304.

In example scenarios where only the aggregation related information is received, the WTRU 102 may derive the supported services of an Aggregation 304 by looking up a database that is hosted locally, in the network or querying an application layer service (e.g., AF/AS). Such a query request may include the Aggregation ID and, optionally, the type of services (a predefined index specifying a service category, e.g., gaming services=1). In response, a query response is received by the WTRU 102, which includes the available services (e.g., predefined service ID/index) for the specific WTRU 102, within the requested category (e.g., Unity game engine=5).

At 420 in FIG. 4A or 418, the Anchor WTRU 208 and/or the 5GS 106 may perform authorization for the services, WTRUs 102 and WTRU Aggregations 304 that are being discovered, to ensure that they can be used for WTRU aggregation, within the specific segment of the network (e.g., an IP subnet/IP range dedicated to a specific service-therefore only available for WTRUs that are within that subnet/IP range) or the geographical location (e.g., within the cell, PLMN), for the specific application. It may also take other parameters, such as, subscription information, WTRU capabilities (defined using a predefined capability index) into consideration. Only some single-modal flows may be supported in some networks. For example, haptic flows may not be supported by certain cells (due to limited resources that are required to provide low latency communication), therefore, only audio and video related services may be authorized.

In some example scenarios, the Anchor WTRU 208 may communicate with the 5GS 106 for authorizing the discovered WTRUs, Services and WTRU Aggregation, for the given network segment or the geographical location. Further, in some example scenario, there may be privileged anchor WTRUs which may perform the authorization on behalf of the network, using the information received from the network. This step may occur before 414 (as shown in FIG. 4A) or after 416 (as shown in FIG. 4B), as shown in an example in FIG. 4.

At 418, the WTRU may receive the discovery response message from the participating WTRUs (in FIG. 4A) or from the Anchor WTRU (in option 2), confirming the creation of a new WTRU Aggregation, confirming their participation in the WTRU Aggregation(s), either for providing services (in case the WTRU provides a service needed by a WTRU Aggregation) or for consuming services (in case the WTRU consumes services provided by the WTRU Aggregation) or both. This message may include the following example information.

The message may include any combination of parameters presented at 416. For example, in scenarios where a certain parameter has been changed/updated (updated particular users/subscribers or WTRU IDs, or a set/subset of them, that the WTRU 102 may know in advance it will communicate directly with or the WTRU Aggregations 304 it may be associated with).

Further, the message may include other WTRUs 102 that are part of the same Aggregation 304. Also, the message may include session information, such as, for example, IDs of multimodal sessions, IDs of multicast and broadcast services (MBS) sessions, and the like. Moreover, this message may include information of the services and the WTRU Aggregations 304 that are supported by the PLMN, Cell, the base station, or WTRUs 102, and information related to how to access those services and WTRU Aggregations 304.

At 422, the member WTRUs 102 and/or the Anchor WTRUs 208 may receive an acknowledgement message confirming the confirmation of the discovery and device association process. This message may include any combination of parameters included at 416.

In an example, ProSe/sidelink connectivity may be established to the chosen known and unknown (i.e., previously unknown but now known due to being discovered) devices at 424. As examples to establish communication: the member/participating WTRU (e.g., WTRU-1 in FIG. 4B) may establish connectivity following the acknowledgement message at 422; and/or an Anchor WTRU 208 may trigger the establishment of the connectivity from the WTRU 102 to the Anchor WTRU 208 by specifying a time value (e.g., a time window at 418 and/or 422 as shown in FIG. 4A); or by sending a trigger message at the time it expects the WTRUs 102 to establish connectivity.

The WTRUs 102 may initiate the direct communication by sending a unicast layer-2 link establishment request message. For example, an establishment request message may be sent via PC5 using PC5 broadcast or unicast using the source Layer-2 ID and the destination Layer-2 ID. Fpr example, ProSe/Sidelink direct communication establishment procedures may be used. The following information may be included in this request.

For example, the request may include user information. The user information may include an ID (e.g., uniquely) identifying the user (e.g., user ID, subscription information), and WTRU's Application Layer ID.

Also, the request may include Source and Destination Layer-2 IDs of the WTRU 102. Further, the request may include the WTRU Aggregation ID, which may (e.g., uniquely) identify the Aggregation 304 of the WTRUs 102. Additionally, the request may include service information, which may include WTRU Aggregation as a new service type, or as ProSe, Sidelink, Multimodal service types. Moreover, the request may include target WTRU information, such as a Target WTRU's Application Layer ID, in an example. In addition, the request may include a time duration, such as the time duration the link must be active or may be used for. Also, the request may include any combination of information specified in other examples provided herein. Further, the request may include information regarding if there already exists a link to the target WTRUs 102, and if so, the WTRU 102 may trigger layer-2 link modification procedure.

WTRUs 102 and the Anchor WTRUs 208 may exchange information related to the direction communication, IP communication related information such as, IP address configuration, local IP address, IP address allocation mechanism (e.g., specifying if acting as IP router or not), QoS information (e.g., latency requirements, bandwidth requirements, a combined/aggregated QOS parameter indicating the QoS level that the aggregated WTRUs 102 must achieve as a collective. In some cases, this may allow devices within a WTRU Aggregation 304 to dynamically share and adjust QoS budgets (e.g., delay budgets) among WTRUs 102 within the WTRU Aggregation 304, allowing to adapt to changes in resource and network conditions) including information about the QoS flows (e.g., specifying their PC5 QoS Flow Identifier (PFI) and PC5 5G QoS Identifier (5QI) (PQI) and associated services) to be added to the specific direct communication link (PC5/ProSe/Sidelink) their corresponding QoS parameters. WTRUs 102 and the Anchor WTRUs 208 may store peer WTRU's layer-2 ID for future communication.

The application (hosted on a mobile device or an AF/AS) may be notified of any newly joined WTRU 102, so that the application is able to make any changes it requires (i.e., the application may adjust its experience to incorporate the new WTRU 102). For example, an initial WTRU Aggregation 304 may only contain two WTRUs 102, such as one display and a gaming controller. Therefore, haptic flows may be transferred directly only to the game controller. Once a third WTRU 102, such as a haptic suit, joins the Aggregation 304, the application may create a separate haptic stream to be transferred to the haptic suit.

In scenarios where a WTRU 102 is discovering existing WTRU Aggregations 304, the Anchor WTRU 208 may play the role of the primary contact for the WTRU Aggregation 304 of interest.

Examples provided herein describe how the network assists in WTRU Aggregation group establishment, through network-assisted WTRU discovery.

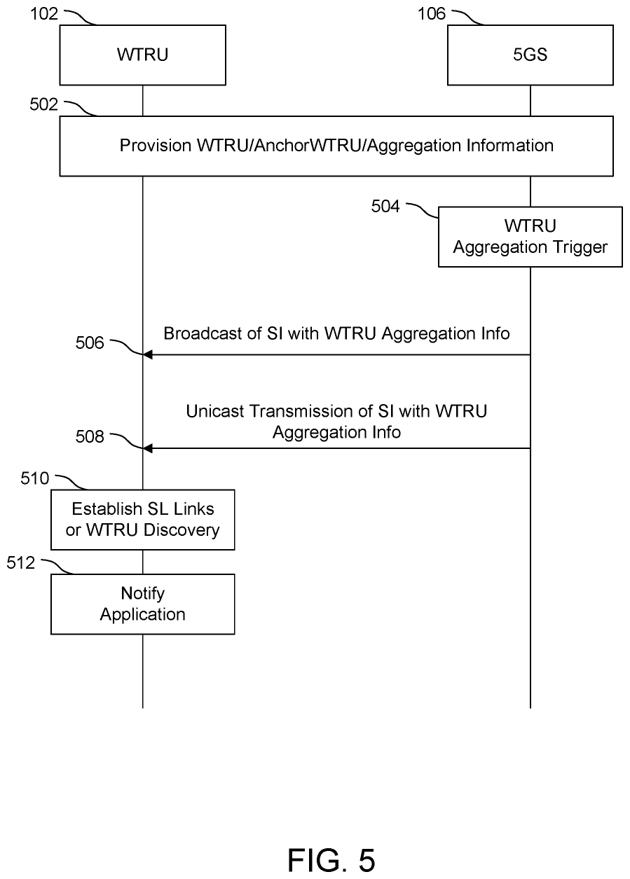

FIG. 5 is a procedure diagram illustrating an example of provisioning WTRU Aggregation information via system information (SI). The following example steps describe the procedures for WTRU-initiated WTRU Aggregation group discovery in an example shown in FIG. 5.

At 502, a WTRU 102 and the network components (e.g., RAN and 5GC components) of the 5GS 106 may be initialized or provisioned with the information of related to WTRU Aggregations 304. This information entails known services, member WTRUs 102, Anchor WTRUs 208, and Aggregations 304 that can be and/or were previously used by the same application or the user/subscriber. Such information may include any combination of the following.

For example, such information may include WTRU Aggregation ID(s), specifying the WTRU Aggregation(s) 304. Further, such information may include a User ID, such as the user/subscriber which the WTRU Aggregation 304 belongs to. Also, such information may include an identifier (e.g., uniquely) identifying a real user (e.g., using subscriber information, such as SUPI/SUCI). Additionally, such information may include session ID(s), which may identify session(s) being used within the application (e.g., multimodal session). Moreover, such information may include WTRU IDs, such as the IDs of the WTRUs 102 that are already known that is or will be part of the WTRU Aggregation 304. In addition, such information may include WTRU capabilities (e.g., sidelink capabilities, game rendering capabilities). Further, such information may include time durations (such as a time duration that the WTRU Aggregation 304 may last and/or time durations that one or multiple D2D communication links may last), and therefore the resource to be allocated. Also, such information may include an application Layer ID, such as Application Layer IDs associated with direct communication within the WTRU Aggregation 304.

Additionally, such information may include information of supported services of WTRUs 102 and/or existing WTRU Aggregations 304. This may include a vector of services, each record containing information of the specific service (e.g., service ID, service requirements, supported multimodal flows).

At 504, the WTRU 102 and WTRU Aggregation 304 discovery may be triggered by various trigger events. Examples of such triggers include, but are not limited to, an application layer notification (from application running on the WTRU 102 or AF/AS in the network) to establish a WTRU Aggregation 304, WTRU 102 and/or Anchor WTRU 208 registration with the 5G system, such as based on a pre-configured time.

At 506, the WTRU 102 may receive information of the WTRUs available for forming new WTRU Aggregations, WTRU Aggregations and services supported (i.e., services available to provide) and/or needed (i.e., services needed by an entity within the network) at the level of PLMN, network segment, cell, base station/gNB, RAN through broadcasted SI) in each cell. This may be either through new SIs allocated for WTRU Aggregation, or through extending existing sidelink SIs (e.g., SIB12, SIB13, SIB14), as known to those of ordinary skill in the art. Any of the WTRUs 102 (e.g., anchor WTRU and/or member WTRU) may access the SI from the network for determining the resources to use for sending discovery messages or data via SL.

The parameters in the information received by the WTRU 102 may include any one of or any combination of the following. For example, the parameters in the information may include supported WTRU Aggregation ID(s). Also, the parameters in the information may include other WTRUs 102 that are available for forming new WTRU Aggregations, and their capabilities (e.g., Sidelink/ProSe capabilities, processing capabilities). Additionally, the parameters in the information may include a ProSe application code/ID, identifying the specific multimodal/XR application. Moreover, the parameters in the information may include time duration/resources, which may include any one of or any combination of time window, a start time, end time, at the level of WTRU Aggregation, or at the level of individual sidelink links. In addition, the parameters in the information may include traffic related requirements information such as UL/DL foreseeable traffic size and type.

Further, the parameters in the information may include a time window (e.g., if the WTRU can produce it) for which the WTRU 102 wants to engage in communications. Also, the information may include particular users/subscribers associated with an identifier (e.g., uniquely) identifying a real user (e.g., using subscriber information, such as SUPI/SUCI). Additionally, the parameters in the information may include WTRU IDs (or a set/subset of them) that the WTRU 102 may know in advance it will communicate directly with or the WTRU Aggregations associated therewith.

Further, this message may include information of the services and the WTRU Aggregations 304 that are supported by the PLMN, cell, the base station, and/or WTRUs 102, and information related to how to access those services and WTRU Aggregations 304. Each record may contain information of the specific service (e.g., service ID, service requirements, supported multimodal flows).

Also, the parameters in the information received by the WTRU 102 may include other WTRUs 102 that are part of a same WTRU Aggregation 304. Moreover, the parameters in the information received by the WTRU 102 may include session information (e.g., IDs of multimodal sessions, IDs of MBS sessions, and the like).

The RAN may indicate via SI, whether any SL resource pools and the associated parameters (e.g. priority, time-frequency resources, periodicity for periodic resources) are pre-allocated per WTRU Aggregation group or can be shared between different WTRU Aggregation groups.

In case only partial information is received, the WTRU 102 may be able to derive or look up other (e.g., remaining) information by referring to a database hosted locally, in the network, or by querying an application layer service (e.g., AF/AS).

At 508, the WTRU 102 may receive information of the WTRUs 102 available for forming new WTRU Aggregations, WTRU Aggregations 304 and/or services supported or needed at the level of PLMN, network segment, cell, base station/gNB, RAN through unicast transmission of SI in each cell. The information provided at 508 may be the same as at 506, and therefore may include the same parameters (e.g., the only difference being that the SI is delivered through unicast instead of multicast). Further, some example cases may use on-demand SI when a WTRU explicitly requests SI to be sent.

Further, in case only partial information is received, the WTRU 102 is able to derive or look up other (e.g., remaining) information by referring to a database hosted locally, in the network, or by querying an application layer services (e.g., AF/AS).

At 510, the (e.g., participating or Anchor) WTRU 102 may access the SI from the network for determining the resources to use for establishing SL links, for sending data or for sending discovery messages.

At 512, the WTRU 102 may notify the application of the discovered services, WTRUs 102 and WTRU Aggregations 304. In some scenarios, 512 may occur after 508 and before 510 (e.g., the newly discovered aggregations need to be used by the application, when deciding which ones to join). It may notify of the newly joined WTRU 102 or WTRU Aggregation 304, so that it is able to make necessary changes. When notifying the application, it may include any combination of parameters presented at 506 and/or 508. Such information may be used later for making application layer changes. For example, information received of other services provided and/or supported by other WTRU Aggregations 304 in the vicinity may allow the application to plan WTRU Aggregations or services that can be incorporated in the future.

The procedures described in embodiments and examples above may or may not be mutually exclusive. Therefore, both WTRU-initiated and network-initiated discovery may be executed simultaneously, combined and/or modified. For example, a WTRU may use the network-initiated discovery procedures to gather information of available WTRU Aggregations, and then may use the WTRU-initiated aggregation procedures to discover an Anchor WTRU 208 and join a WTRU Aggregation 304.

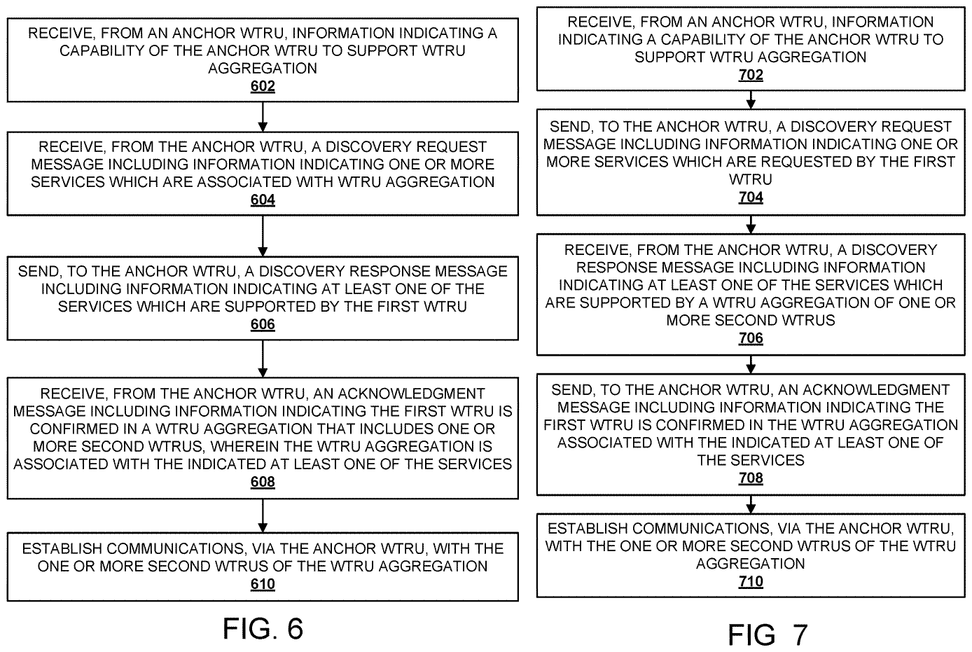

FIG. 6 is a procedural diagram illustrating an example of WTRU aggregation discovery for a WTRU 102. The example procedure may be implemented as a method by a first WTRU 102. The first WTRU 102 may receive, from an anchor WTRU 208, information indicating a capability of the anchor WTRU 208 to support WTRU aggregation at 602. At 604, the first WTRU 102 may receive, from the anchor WTRU 208, a discovery request message including information indicating one or more services which are associated with WTRU aggregation. At 606, the first WTRU 102 may send, to the anchor WTRU 208, a discovery response message including information indicating at least one of the services which are supported by the first WTRU 102. At 608, the first WTRU 102 may receive, from the anchor WTRU 208, an acknowledgment message including information indicating the first WTRU 102 is confirmed in a WTRU Aggregation 304 that includes one or more second WTRUs 206. The WTRU Aggregation 304 is associated with the indicated at least one of the services. At 610, the first WTRU 102 may establish communications, via the anchor WTRU 208, with the one or more second WTRUs 206 of the WTRU Aggregation 304.

In certain representative embodiments, the first WTRU 102 may receive configuration information indicating time/frequency resources associated with communicating with the anchor WTRU 208. For example, any of (i) the information indicating the capability of the anchor WTRU to support WTRU aggregation, (ii) the discovery request message, (iii) the discovery response message and/or (iv) the acknowledgment message is communicated via the indicated time/frequency resources. For example, data associated with the indicated at least one of the services may be transmitted and/or received by the first WTRU 102 using the indicated time/frequency resources.

In certain representative embodiments, the first WTRU 102 may receive information indicating one or more known anchor WTRUs. In FIG. 6, the anchor WTRU 208 may be included in the indicated one or more known anchor WTRUs.

In certain representative embodiments, the first WTRU 102 may register (e.g., perform registration) with a network. For example, the information indicating the one or more known anchor WTRUs may be received in a configuration message after registering with the network.

In certain representative embodiments, the acknowledgement message received from the anchor WTRU 208 may include information identifying the one or more second WTRUs 206 and/or identifying the WTRU Aggregation 304.

In certain representative embodiments, the capability of the anchor WTRU 208 to support WTRU aggregation may be any of a vehicle-to-everything (V2X), proximity services (ProSe), or sidelink (SL) capability indication.

In certain representative embodiments, the information indicating the capability of the anchor WTRU 208 to support WTRU aggregation may be included in a broadcast and/or multicast message.

In certain representative embodiments, the information indicating at least one of the services which are supported by the first WTRU 102 may further include information indicating any of a service identifier, one or more requirements, and/or one or more multimodal flows associated with the at least one of the services supported by the first WTRU 102.

In certain representative embodiments, the one or more services are associated with an application executed by the WTRU Aggregation 304 and/or an application executed by the first WTRU 102.

In certain representative embodiments, the first WTRU 102 may notify an application associated with the one or more services that the first WTRU 102 is confirmed in the WTRU Aggregation 304.

FIG. 7 is a procedural diagram illustrating another example of WTRU aggregation discovery for a WTRU 102. The example procedure may be implemented as a method by a first WTRU 102. At 702, the first WTRU 102 may receive, from an anchor WTRU 208, information indicating a capability of the anchor WTRU 208 to support WTRU aggregation. At 704, the first WTRU 102 may send, to the anchor WTRU 208, a discovery request message including information indicating one or more services which are requested by the first WTRU 102. At 706, the first WTRU 102 may receive, from the anchor WTRU 208, a discovery response message including information indicating at least one of the services which are supported by a WTRU Aggregation 304 of one or more second WTRUs 206. At 708, the first WTRU 102 may send, to the anchor WTRU 208, an acknowledgment message including information indicating the first WTRU 102 is confirmed in the WTRU Aggregation 304 associated with the indicated at least one of the services. At 710, the first WTRU 102 may (e.g., perform a procedure to) establish communications, via the anchor WTRU 208, with the one or more second WTRUs 206 of the WTRU Aggregation 304.

In certain representative embodiments, the first WTRU 102 may receive configuration information indicating time/frequency resources associated with communicating with the anchor WTRU. For example, any of (i) the information indicating the capability of the anchor WTRU to support WTRU aggregation, (ii) the discovery request message, (iii) the discovery response message and/or (iv) the acknowledgment message is communicated via the indicated time/frequency resources. For example, data associated with the indicated at least one of the services may be transmitted and/or received by the first WTRU 102 using the indicated time/frequency resources.

In certain representative embodiments, the first WTRU 102 may receive information indicating one or more known anchor WTRUs. For example, the anchor WTRU 208 may be included in the indicated one or more known anchor WTRUs.

In certain representative embodiments, the first WTRU 102 may register (e.g., perform registration) with a network. For example, the one or more known anchor WTRUs may be received in a configuration message after registering with the network.

In certain representative embodiments, the acknowledgement message received from the anchor WTRU 208 may include information identifying the one or more second WTRUs 206 and/or identifying the WTRU Aggregation 304.

In certain representative embodiments, the capability of the anchor WTRU 208 to support WTRU aggregation may be any of a vehicle-to-everything (V2X), proximity services (ProSe), or sidelink (SL) capability indication.

In certain representative embodiments, the information indicating the capability of the anchor WTRU 208 to support WTRU aggregation may be included in a broadcast and/or multicast message.

In certain representative embodiments, the information indicating at least one of the services which are supported by the first WTRU 102 may further include information indicating any of a service identifier, one or more requirements, and/or one or more multimodal flows associated with the at least one of the services supported by the first WTRU 102.

In certain representative embodiments, the one or more services may be associated with an application executed by the WTRU Aggregation 304 and/or an application executed by the first WTRU 102.

In certain representative embodiments, the first WTRU 102 may notify an application associated with the one or more services that the first WTRU 102 is confirmed in the WTRU Aggregation 304.

In certain representative embodiments, the discovery request message may be sent at a timing associated with any of (i) a WTRU density in a vicinity of the first WTRU 102 satisfying a threshold, and/or (ii) one or more resources of the first WTRU 102 satisfying a threshold.

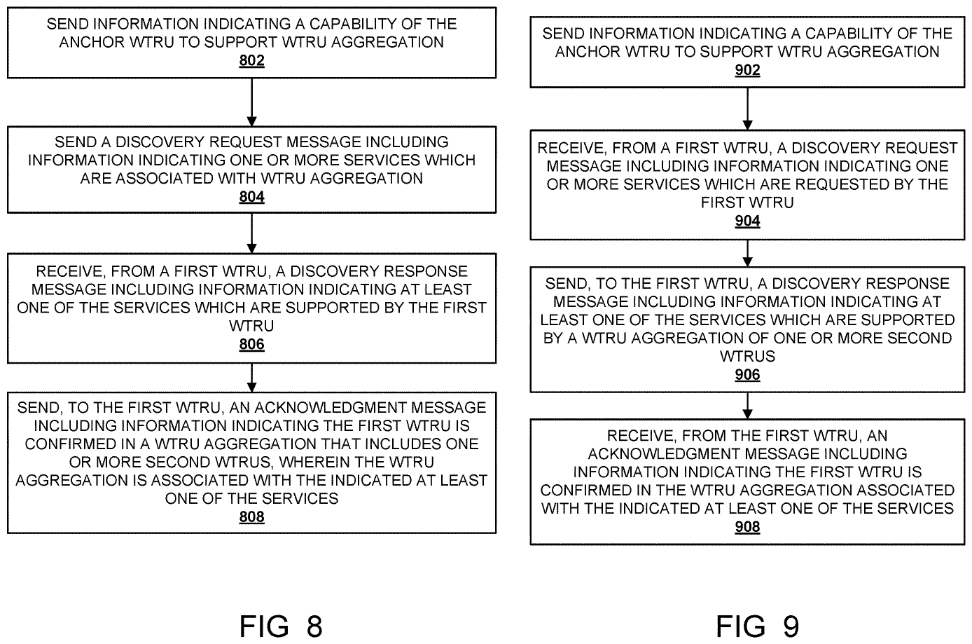

FIG. 8 is a procedural diagram illustrating an example of WTRU aggregation discovery for an anchor WTRU 208. The example procedure may be implemented as a method by the anchor WTRU 208. At 802, the anchor WTRU 802 may send information indicating a capability of the anchor WTRU 208 to support WTRU aggregation. At 804, the anchor WTRU 208 may send a discovery request message including information indicating one or more services which are associated with WTRU aggregation. At 806, the anchor WTRU 208 may receive, from a first WTRU 102, a discovery response message including information indicating at least one of the services which are supported by the first WTRU 102. At 808, the anchor WTRU 208 may send, to the first WTRU 102, an acknowledgment message including information indicating the first WTRU 102 is confirmed in a WTRU Aggregation 304 that includes one or more second WTRUs 206. The WTRU Aggregation 304 is associated with the indicated at least one of the services.

In certain representative embodiments, the anchor WTRU 208 may receive configuration information indicating time/frequency resources associated with communicating with the first WTRU 102. For example, any of (i) the information indicating the capability of the anchor WTRU to support WTRU aggregation, (ii) the discovery request message, (iii) the discovery response message and/or (iv) the acknowledgment message is communicated via the indicated time/frequency resources. For example, data associated with the indicated at least one of the services may be transmitted and/or received by the anchor WTRU 208 using the indicated time/frequency resources.

In certain representative embodiments, the information indicating the capability of the anchor WTRU 208 to support WTRU aggregation is included in a broadcast and/or multicast message.

In certain representative embodiments, the anchor WTRU 208 may establish (e.g., perform a procedure to establish) a sidelink (SL) connection or a Proximity Service (ProSe) connection with the first WTRU 102.

FIG. 9 is a procedural diagram illustrating another example of WTRU aggregation discovery for an anchor WTRU 208. The example procedure may be implemented as a method by the anchor WTRU 208. At 902, the anchor WTRU 208 may send information indicating a capability of the anchor WTRU 208 to support WTRU aggregation. At 904, the anchor WTRU 208 may receive, from a first WTRU 102, a discovery request message including information indicating one or more services which are requested by the first WTRU 102. At 906, the anchor WTRU 208 may send, to the first WTRU 102, a discovery response message including information indicating at least one of the services which are supported by a WTRU Aggregation 304 of one or more second WTRUs 206. At 908, the anchor WTRU 208 may receive, from the first WTRU 102, an acknowledgment message including information indicating the first WTRU 102 is confirmed in the WTRU Aggregation 304 associated with the indicated at least one of the services.

In certain representative embodiments, the anchor WTRU 208 may receive configuration information indicating time/frequency resources associated with communicating with the first WTRU 102. For example, any of (i) the information indicating the capability of the anchor WTRU to support WTRU aggregation, (ii) the discovery request message, (iii) the discovery response message and/or (iv) the acknowledgment message is communicated via the indicated time/frequency resources. For example, data associated with the indicated at least one of the services may be transmitted and/or received by the anchor WTRU 208 using the indicated time/frequency resources.

In certain representative embodiments, the information indicating the capability of the anchor WTRU 208 to support WTRU aggregation is included in a broadcast and/or multicast message.

In certain representative embodiments, the anchor WTRU 208 may establish (e.g., perform a procedure to establish) a sidelink (SL) connection or a Proximity Service (ProSe) connection with the first WTRU.

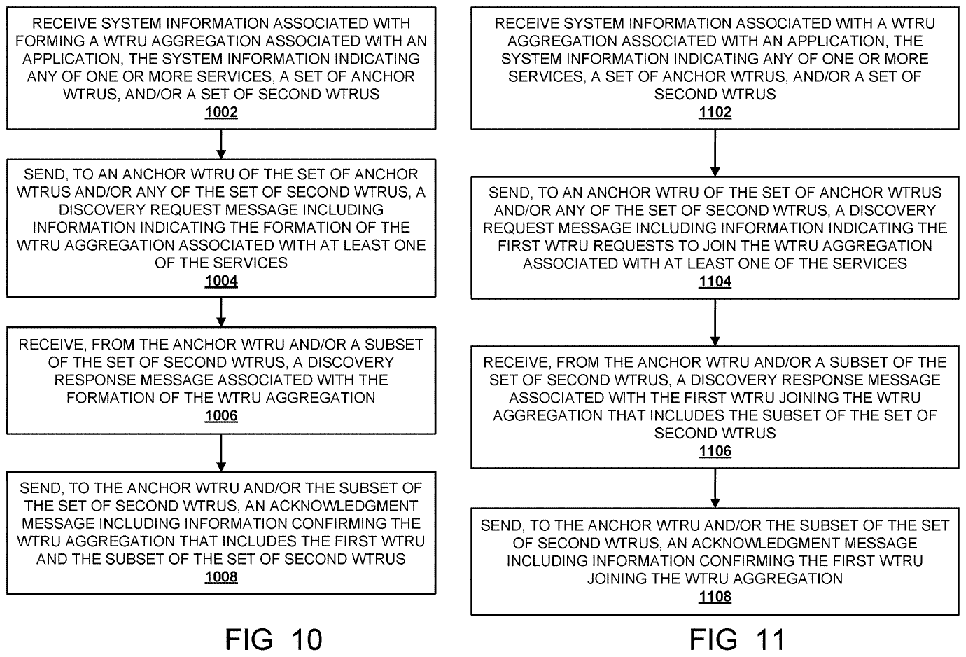

FIG. 10 is a procedural diagram illustrating an example of using SI for forming a WTRU aggregation 304. The example procedure may be implemented as a method by a first WTRU 102. At 1002, the first WTRU 102 may receive SI associated with forming a WTRU Aggregation 304 associated with an application. For example, the SI may indicate any of one or more services, a set of anchor WTRUs 208, and/or a set of second WTRUs 102/206. At 1004, the first WTRU 102 may send, to an anchor WTRU 208 of the set of anchor WTRUs and/or any of the set of second WTRUs 206, a discovery request message including information indicating the formation of the WTRU Aggregation 304 associated with at least one of the services. At 1006, the first WTRU 102 may receive, from the anchor WTRU 208 and/or a subset of the set of second WTRUs 206, a discovery response message associated with the formation of the WTRU Aggregation 304. At 1008, the first WTRU 102 may send, to the anchor WTRU 208 and/or the subset of the set of second WTRUs 206, an acknowledgment message including information confirming the WTRU Aggregation that includes the first WTRU 102 and the subset of the set of second WTRUs 206.

In certain representative embodiments, the SI may be included in a broadcast transmission and/or a unicast transmission.

In certain representative embodiments, the SI may be received in response to a notification from the application, in response to registration of the first WTRU 102 with the network, and/or at a preconfigured time.

In certain representative embodiments, the SI may include configuration information indicating time/frequency resources associated with communicating with the anchor WTRU 208 and/or the subset of the set of second WTRUs 206. For example, any of (i) the discovery request message, (ii) the discovery response message and/or (iii) the acknowledgment message may be communicated via the indicated time/frequency resources. For example, data associated with the indicated at least one of the services may be transmitted and/or received using the indicated time/frequency resources.

In certain representative embodiments, the SI may include any of capabilities of the set of second WTRUs 206, a time duration associated with the WTRU Aggregation 304 and/or the set of second WTRUs 206, user information, and/or one or more multimodal flows associated with the one or more services.

In certain representative embodiments, the SI may indicate the WTRU Aggregation 304 is supported by any of a PLMN, a cell, and/or a base station (e.g., gNB 180).

In certain representative embodiments, the first WTRU 102 may execute the application and receive data associated with the indicated at least one of the services from the WTRU Aggregation 304.

In certain representative embodiments, the first WTRU 102 may send data associated with the indicated at least one of the services to the application executed by the network.

FIG. 11 is a procedural diagram illustrating an example of using SI for joining a WTRU aggregation 304. The example procedure may be implemented as a method by a first WTRU 102. At 1102, the first WTRU 102 may receive SI associated with a WTRU Aggregation 304 associated with an application. For example, the SI may indicate any of one or more services, a second set of anchor WTRUs 208, and/or a second set of second WTRUs 206. At 1104, the first WTRU 102 may send, to an anchor WTRU 208 of the second set of anchor WTRUs and/or any of the second set of second WTRUs 206, a discovery request message including information indicating the first WTRU requests to join the WTRU aggregation associated with at least one of the services. At 1106, the first WTRU 102 may receive, from the anchor WTRU 208 and/or a subset of the set of second WTRUs 206, a discovery response message associated with the first WTRU 102 joining the WTRU Aggregation 304 that includes the subset of the set of second WTRUs 206. At 1108, the first WTRU 102 may send, to the anchor WTRU 208 and/or the subset of the set of second WTRUs 206, an acknowledgment message including information confirming the first WTRU 102 joining the WTRU Aggregation 304.

In certain representative embodiments, the SI may be included in a broadcast transmission and/or a unicast transmission.

In certain representative embodiments, the SI may be received in response to a notification from the application, in response to registration of the first WTRU 102 with the network, and/or at a preconfigured time.

In certain representative embodiments, the SI may include configuration information indicating time/frequency resources associated with communicating with the anchor WTRU 208 and/or the subset of the set of second WTRUs 206. For example, any of (i) the discovery request message, (ii) the discovery response message and/or (iii) the acknowledgment message may be communicated via the indicated time/frequency resources. For example, data associated with the indicated at least one of the services may be transmitted and/or received using the indicated time/frequency resources.

In certain representative embodiments, the SI may include any of capabilities of the set of second WTRUs 206, a time duration associated with the WTRU Aggregation 304 and/or the set of second WTRUs 206, user information, and/or one or more multimodal flows associated with the one or more services.

In certain representative embodiments, the SI may indicate the WTRU Aggregation 304 is supported by any of a PLMN, a cell, and/or a base station (e.g., gNB 180).

In certain representative embodiments, the first WTRU 102 may execute the application and receive data associated with the indicated at least one of the services from the WTRU Aggregation 304.

In certain representative embodiments, the first WTRU 102 may send data associated with the indicated at least one of the services to the application executed by the network.

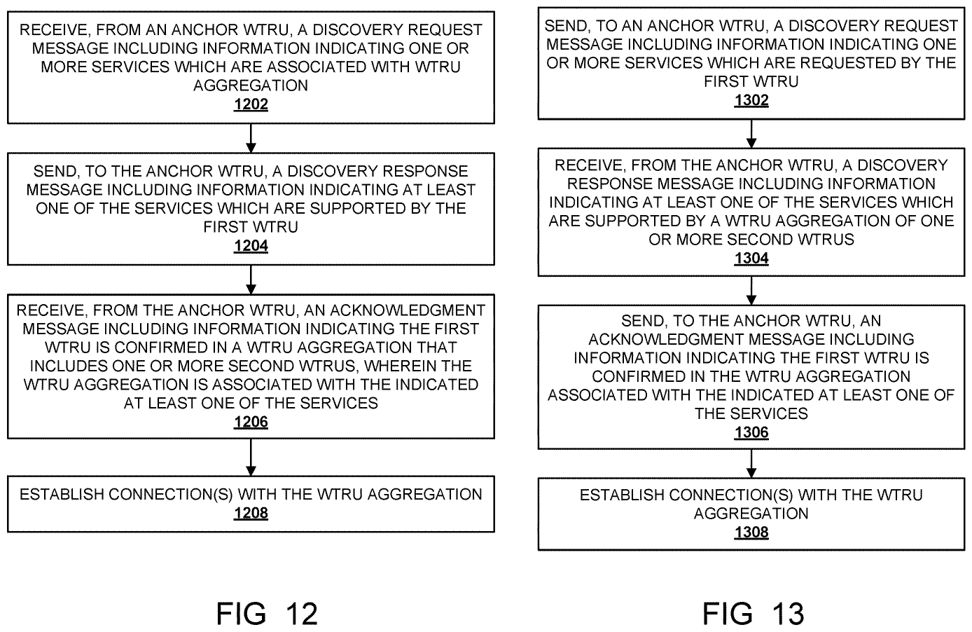

FIG. 12 is a procedural diagram illustrating an example of WTRU aggregation discovery. The example procedure may be implemented as a method by a first WTRU 102. At 1202, the first WTRU 102 may receive, from an anchor WTRU 208, a discovery request message including information indicating one or more services which are associated with WTRU aggregation. At 1204, the first WTRU 102 may send, to the anchor WTRU 208, a discovery response message including information indicating at least one of the services which are supported by the first WTRU 102. At 1206, the first WTRU 102 may receive, from the anchor WTRU 208, an acknowledgment message including information indicating the first WTRU 102 is confirmed in a WTRU Aggregation 304 that includes one or more second WTRUs 206. The WTRU aggregation 304 is associated with the indicated at least one of the services. At 1208, the first WTRU 102 may (e.g., perform a procedure to) establish connection(s) with the WTRU Aggregation 304.

In certain representative embodiments, the connections with the WTRU Aggregation 304 may be established via the anchor WTRU 208.

In certain representative embodiments, the connections with the WTRU Aggregation 304 may be established with each of the one or more second WTRUs 206.

In certain representative embodiments, the connections with the WTRU Aggregation 304 may be Proximity Services (ProSe) connections.

In certain representative embodiments, the connections with the WTRU Aggregation 304 may be sidelink (SL) connections.

In certain representative embodiments, the connections with the WTRU Aggregation 304 may be triggered by a message from the anchor WTRU 208 or a specified time indicated in the acknowledgment message.

In certain representative embodiments, the connections with the WTRU Aggregation 304 may be established by a procedure which includes sending PC5 broadcast or unicast messages to any of the anchor WTRU 208 and/or the one or more second WTRUs 206. For example, the messages may include information indicating any of a user identifier of the first WTRU 102, source and destination identifiers of the first WTRU 102, an identifier of the WTRU Aggregation 304, service types of the indicated at least one of the services, a target WTRU identifier, and/or a time duration of the WTRU Aggregation 304.

FIG. 13 is a procedural diagram illustrating another example of WTRU aggregation discovery. The example procedure may be implemented as a method by a first WTRU 102. At 1302, the first WTRU 102 may send, to an anchor WTRU 208, a discovery request message including information indicating one or more services which are requested by the first WTRU 102. At 1304, the first WTRU 102 may receive, from the anchor WTRU 208, a discovery response message including information indicating at least one of the services which are supported by a WTRU Aggregation 304 of one or more second WTRUs 206. At 1306, the first WTRU 102 may send, to the anchor WTRU 208, an acknowledgment message including information indicating the first WTRU 102 is confirmed in the WTRU Aggregation 304 associated with the indicated at least one of the services. At 1308, the first WTRU 102 may (e.g., perform a procedure to) establish a connection(s) with the WTRU Aggregation 304.

In certain representative embodiments, the connections with the WTRU Aggregation 304 may be established via the anchor WTRU 208.

In certain representative embodiments, the connections with the WTRU Aggregation 304 may be established with each of the one or more second WTRUs 206.

In certain representative embodiments, the connections with the WTRU Aggregation 304 may be Proximity Services (ProSe) connections.

In certain representative embodiments, the connections with the WTRU Aggregation 304 may be sidelink (SL) connections.

In certain representative embodiments, the connections with the WTRU Aggregation 304 may be triggered by a message from the anchor WTRU 208 or a specified time indicated in the acknowledgment message.

In certain representative embodiments, the connections with the WTRU Aggregation 304 may be established by a procedure which includes sending PC5 broadcast or unicast messages to any of the anchor WTRU 208 and/or the one or more second WTRUs 206. For example, the messages may include information indicating any of a user identifier of the first WTRU 102, source and destination identifiers of the first WTRU 102, an identifier of the WTRU Aggregation 304, service types of the indicated at least one of the services, a target WTRU identifier, and/or a time duration of the WTRU Aggregation 304.

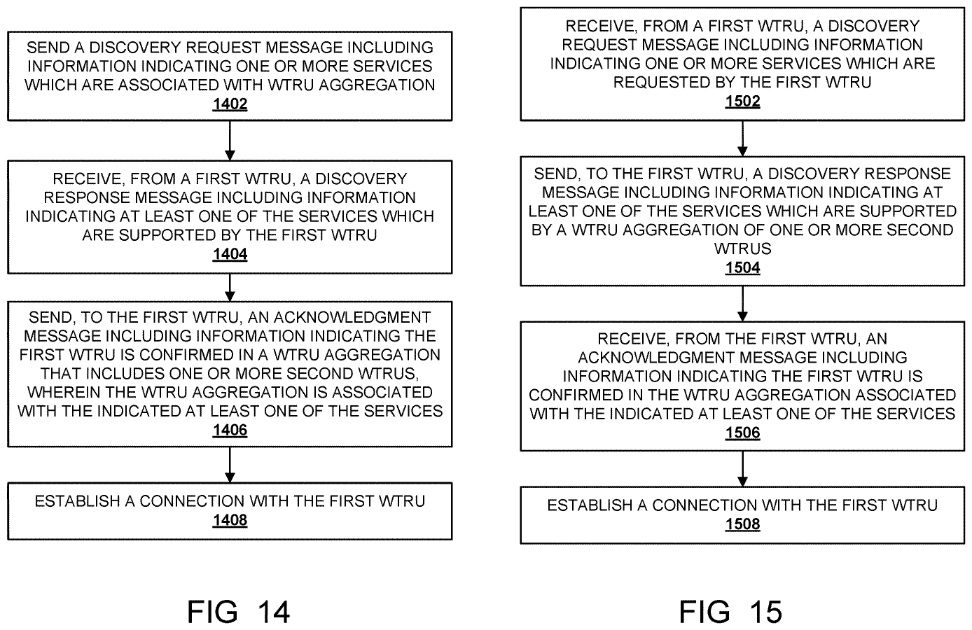

FIG. 14 is a procedural diagram illustrating another example of WTRU aggregation discovery. The example procedure may be implemented as a method by an anchor WTRU 208. At 1402, the anchor WTRU 208 may send a discovery request message including information indicating one or more services which are associated with WTRU aggregation. At 1404, the anchor WTRU 208 may receive, from a first WTRU 102, a discovery response message including information indicating at least one of the services which are supported by the first WTRU 102. At 1406, the anchor WTRU 208 may send, to the first WTRU 102, an acknowledgment message including information indicating the first WTRU 102 is confirmed in a WTRU Aggregation 304 that includes one or more second WTRUs 206. The WTRU aggregation 304 is associated with the indicated at least one of the services. At 1408, the anchor WTRU 208 may (e.g., perform a procedure to) establish a connection with the first WTRU 102.

In certain representative embodiments, the anchor WTRU 208 may (e.g., perform procedures to) establish connections with the one or more second WTRUs 206.

In certain representative embodiments, the connection with the first WTRU 102 and/or WTRU Aggregation 304 is/are ProSe connections.

In certain representative embodiments, the connections with the first WTRU 102 and/or WTRU Aggregation 304 is/are SL connections.

In certain representative embodiments, the establishing of the connection with the first WTRU 102 may be triggered by a message from the anchor WTRU 208 or a specified time indicated in the acknowledgment message.

In certain representative embodiments, the establishing of the connection with the first WTRU 102 and/or WTRU aggregation 304 may include receiving a PC5 broadcast or unicast message from the first WTRU 102. For example, the message may include information indicating any of a user identifier of the first WTRU 102, source and destination identifiers of the first WTRU 102, an identifier of the WTRU Aggregation 304, service types of the indicated at least one of the services, a target WTRU identifier, and/or a time duration of the WTRU Aggregation 304.

FIG. 15 is a procedural diagram illustrating another example of WTRU aggregation discovery. The example procedure may be implemented as a method by an anchor WTRU 208. At 1502, the anchor WTRU 208 may receive, from a first WTRU 102, a discovery request message including information indicating one or more services which are requested by the first WTRU 102. At 1504, the anchor WTRU 208 may send, to the first WTRU 102, a discovery response message including information indicating at least one of the services which are supported by a WTRU Aggregation 304 of one or more second WTRUs 206. At 1506 the anchor WTRU 208 may receive, from the first WTRU 102, an acknowledgment message including information indicating the first WTRU 102 is confirmed in the WTRU Aggregation 304 associated with the indicated at least one of the services. At 1508, the anchor WTRU 208 may (e.g., perform a procedure to) establish a connection with the first WTRU 102.

In certain representative embodiments, the anchor WTRU 208 may (e.g., perform procedures to) establish connections with the one or more second WTRUs 206.

In certain representative embodiments, the connection with the first WTRU 102 and/or WTRU Aggregation 304 is/are ProSe connections.

In certain representative embodiments, the connections with the first WTRU 102 and/or WTRU Aggregation 304 is/are SL connections.

In certain representative embodiments, the establishing of the connection with the first WTRU 102 may be triggered by a message from the anchor WTRU 208 or a specified time indicated in the acknowledgment message.

In certain representative embodiments, the establishing of the connection with the first WTRU 102 and/or WTRU aggregation 304 may include receiving a PC5 broadcast or unicast message from the first WTRU 102. For example, the message may include information indicating any of a user identifier of the first WTRU 102, source and destination identifiers of the first WTRU 102, an identifier of the WTRU Aggregation 304, service types of the indicated at least one of the services, a target WTRU identifier, and/or a time duration of the WTRU Aggregation 304.

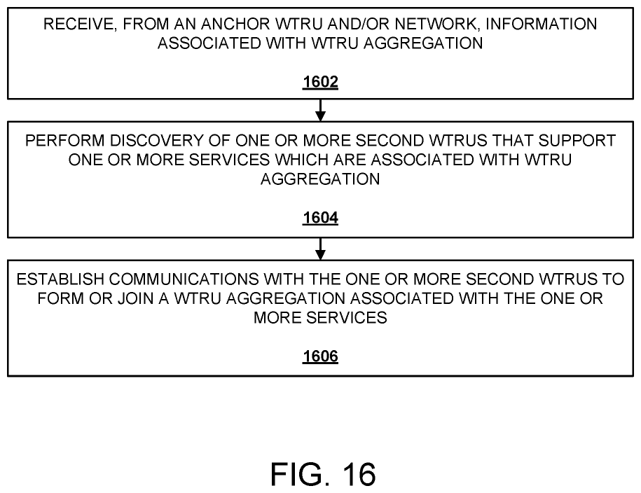

FIG. 16 is a procedural diagram illustrating an example of connecting to a WTRU Aggregation 308. The example procedure may be implemented as a method by a wireless device, such as a first WTRU 102. At 1602, the wireless device may receive, from an anchor WTRU 208 and/or network, information associated with WTRU aggregation. At 1604, the wireless device may perform discovery of one or more second WTRUs 206 that support one or more services which are associated with WTRU aggregation. At 1606, the wireless device may establish communications with the one or more second WTRUs 206 to form or join a WTRU Aggregation 304 associated with the one or more services.

In certain representative embodiments, the communications with the one or more second WTRUs 206 may be established via the anchor WTRU 208.

In certain representative embodiments, a wireless device may perform a method which includes receiving information related to wireless transmit/receive unit (WTRU) Aggregation, and transmitting a registration request message.

In some representative embodiments, the wireless device may further perform receiving a registration accept message, transmitting a registration complete message, and receiving a configuration message, wherein the configuration message includes information regarding an Anchor WTRU.

In some representative embodiments, the wireless device may further perform triggering WTRU Aggregation discovery, and detecting device density.

In some representative embodiments, the wireless device may further perform transmitting a discovery request message, authorizing a requested service, and receiving a discovery response message.

In some representative embodiments, the wireless device may further perform transmitting a discovery acknowledgement (ACK).

In some representative embodiments, the wireless device may further perform establishing sidelink (SL) and Uu communications, and notifying an application of a newly joined WTRU.

In certain representative embodiments, a User identity (ID) is included in one or more of the information related to WTRU Aggregation, the registration request message, the discovery request message, or the discovery response message.

In some representative embodiments, the wireless device may further perform receiving a broadcast system information (SI) message with WTRU Aggregation information.

In some representative embodiments, the wireless device may further perform receiving a unicast transmission of SI with WTRU Aggregation information.

In some representative embodiments, the wireless device may further perform establishing WTRU discovery.

In certain representative embodiments, the information related to WTRU Aggregation includes one or more of: known services, known member WTRUs, known anchor WTRUs and known aggregations.

In certain representative embodiments, the registration request includes an indication of an ability of a WTRU to become an Anchor WTRU.

In certain representative embodiments, the wireless device is a WTRU.

In certain representative embodiments, the wireless device is an Anchor WTRU.

In certain representative embodiments, the wireless device is an SL WTRU.

In certain representative embodiments, the wireless device is transmitting WTRU.

In certain representative embodiments, the wireless device is a receiving WTRU.

In certain representative embodiments, the wireless device is a proximity services (ProSe) WTRU.

In certain representative embodiments, the wireless device is a collaborative WTRU.

In certain representative embodiments, the wireless device is an access point (AP).

In certain representative embodiments, the wireless device is a station (STA).

In certain representative embodiments, the wireless device is a watch.

In certain representative embodiments, the wireless device is a head mounted display (HMD).

In certain representative embodiments, the wireless device is a vehicle.

In certain representative embodiments, the wireless device is a drone.

In certain representative embodiments, the wireless device is a fixed wireless access (FWA) device.

In certain representative embodiments, the wireless device is an industrial device.

In certain representative embodiments, the wireless device is a user equipment (UE).

In certain representative embodiments, the wireless device is a base station.

In certain representative embodiments, the wireless device is a transmission and reception point (TRP).

In certain representative embodiments, the wireless device is a multi-TRP (M-TRP).

In certain representative embodiments, the wireless device is a network node.

In certain representative embodiments, the wireless device is a relay node.

In certain representative embodiments, the wireless device is an eNode-B.

In certain representative embodiments, the wireless device is a gNode B (gNB).

In certain representative embodiments, the wireless device is a network-controlled repeater (NCR).

In certain representative embodiments, the wireless device is a tablet.

In certain representative embodiments, the wireless device is a customer premises equipment (CPE).

In certain representative embodiments, a WTRU may perform a method which includes receiving information related to WTRU Aggregation, transmitting a registration request message, receiving a registration accept message, transmitting a registration complete message, and receiving a configuration message. The configuration message may include information regarding an Anchor WTRU. The WTRU may perform triggering WTRU Aggregation discovery, detecting device density, transmitting a discovery request message, authorizing a requested service, receiving a discovery response message, transmitting a discovery acknowledgement (ACK), establishing sidelink (SL) and Uu communications, and notifying an application of a newly joined WTRU.

In certain representative embodiments, a User identity (ID) is included in one or more of the information related to WTRU Aggregation, the registration request message, the discovery request message, or the discovery response message.

Any of the procedures illustrated in FIGS. 6 to 16 may be combined and/or modified to include and/or omit features which are otherwise described herein, such as with respect to any of the features shown in FIGS. 4A, 4B and 5.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.” One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a first wireless transmit/receive unit (WTRU), the method comprising:
receiving, from an anchor WTRU, information indicating a capability of the anchor WTRU to support WTRU aggregation;
receiving, from the anchor WTRU, a discovery request message including information indicating one or more services which are associated with WTRU aggregation;
sending, to the anchor WTRU, a discovery response message including information indicating at least one of the services which are supported by the first WTRU;
receiving, from the anchor WTRU, an acknowledgment message including information indicating the first WTRU is confirmed in a WTRU aggregation that includes one or more second WTRUs, wherein the WTRU aggregation is associated with the indicated at least one of the services; and
establishing communications, via the anchor WTRU, with the one or more second WTRUs of the WTRU aggregation.

2. The method of claim 1, further comprising:
receiving configuration information indicating time/frequency resources associated with communicating with the anchor WTRU,
wherein any of (i) the information indicating the capability of the anchor WTRU to support WTRU aggregation, (ii) the discovery request message, (iii) the discovery response message and/or (iv) the acknowledgment message is communicated via the indicated time/frequency resources.

3. The method of claim 1, further comprising:
receiving information indicating one or more known anchor WTRUs, wherein the anchor WTRU is included in the indicated one or more known anchor WTRUS.

4. The method of claim 3, further comprising:
registering with a network, wherein the information indicating the one or more known anchor WTRUs is received in a configuration message after registering with the network.

5. The method of claim 1, wherein the acknowledgement message received from the anchor WTRU includes information identifying the one or more second WTRUs and/or identifying the WTRU aggregation.

6. The method of claim 1, wherein the capability of the anchor WTRU to support WTRU aggregation is any of a vehicle-to-everything (V2X), proximity services (ProSe), or sidelink (SL) capability indication.

7. The method of claim 1, wherein the information indicating the capability of the anchor WTRU to support WTRU aggregation is included in a broadcast and/or multicast message.

8. The method of claim 1, wherein the information indicating at least one of the services which are supported by the first WTRU further includes information indicating any of a service identifier, one or more requirements, and/or one or more multimodal flows associated with the at least one of the services supported by the first WTRU.

9. The method of claim 1, wherein the one or more services are associated with an application executed by the WTRU aggregation and/or an application executed by the first WTRU.

10. The method of claim 1, further comprising:
notifying an application associated with the one or more services that the first WTRU is confirmed in the WTRU aggregation.

11-21. (canceled)

22. A first wireless transmit/receive unit (WTRU) comprising:
a processor, memory, and a transceiver which are configured to:
receive, from an anchor WTRU, information indicating a capability of the anchor WTRU to support WTRU aggregation,
receive, from the anchor WTRU, a discovery request message including information indicating one or more services which are associated with WTRU aggregation,
send, to the anchor WTRU, a discovery response message including information indicating at least one of the services which are supported by the first WTRU,
receive, from the anchor WTRU, an acknowledgment message including information indicating the first WTRU is confirmed in a WTRU aggregation that includes one or more second WTRUs, wherein the WTRU aggregation is associated with the indicated at least one of the services, and
establish communications, via the anchor WTRU, with the one or more second WTRUs of the WTRU aggregation.

23. The first WTRU of claim 22, wherein the processor, memory, and the transceiver are configured to receive configuration information indicating time/frequency resources associated with communicating with the anchor WTRU,
wherein any of (i) the information indicating the capability of the anchor WTRU to support WTRU aggregation, (ii) the discovery request message, (iii) the discovery response message and/or (iv) the acknowledgment message is communicated via the indicated time/frequency resources.

24. The first WTRU of claim 22, wherein the processor, memory, and the transceiver are configured to receive information indicating one or more known anchor WTRUS,
wherein the anchor WTRU is included in the indicated one or more known anchor WTRUS.

25. The first WTRU of claim 24, wherein the processor, memory, and the transceiver are configured to register with a network,
wherein the information indicating the one or more known anchor WTRUs is received in a configuration message after registering with the network.

26. The first WTRU of claim 22, wherein the acknowledgement message received from the anchor WTRU includes information identifying the one or more second WTRUs and/or identifying the WTRU aggregation.

27. The first WTRU of claim 22, wherein the capability of the anchor WTRU to support WTRU aggregation is any of a vehicle-to-everything (V2X), proximity services (ProSe), or sidelink (SL) capability indication.

28. The first WTRU of claim 22, wherein the information indicating the capability of the anchor WTRU to support WTRU aggregation is included in a broadcast and/or multicast message.

29. The first WTRU of claim 22, wherein the information indicating at least one of the services which are supported by the first WTRU further includes information indicating any of a service identifier, one or more requirements, and/or one or more multimodal flows associated with the at least one of the services supported by the first WTRU.

30. The first WTRU of claim 22, wherein the one or more services are associated with an application executed by the WTRU aggregation and/or an application executed by the first WTRU.

31. The first WTRU of claim 22, wherein the processor, memory, and the transceiver are configured to notify an application associated with the one or more services that the first WTRU is confirmed in the WTRU aggregation.

32-42. (canceled)
